(19) United States
(12) Patent Application Publication
(10) Pub. No.: US 2026/0256200 A1
(43) Pub. Date: Sep. 3, 2026

(54) AEROSOL GENERATING DEVICE

(71) Applicants: KT&G CORPORATION, Daejeon (KR); KOREA ELECTROTECHNOLOGY RESEARCH INSTITUTE, Changwon-si, Gyeongsangnam-do (KR)

(72) Inventors: In Su PARK, Daejeon (KR); Chan Min KWON, Daejeon (KR); Tae Kyun KIM, Daejeon (KR); Mi Jeong LEE, Daejeon (KR); John Tae LEE, Daejeon (KR); Tae Kyung LEE, Daejeon (KR); Dae Ho KIM, Changwon-si, Gyeongsangnam-do (KR); Ji Won SHIN, Changwon-si, Gyeongsangnam-do (KR)

(73) Assignees: KT&G CORPORATION, Daejeon (KR); KOREA ELECTROTECHNOLOGY RESEARCH INSTITUTE, Changwon-si, Gyeongsangnam-do (KR)

(21) Appl. No.: 18/879,912

(22) PCT Filed: Aug. 31, 2023
(86) PCT No.: PCT/KR2023/013039

§ 371 Date: Dec. 30, 2024

(30) Foreign Application Priority Data
Aug. 31, 2022 (KR) 10-2022-0110268
Aug. 30, 2023 (KR) 10-2023-0114653

(51) Int. Cl. A24F 40/46; A24F 40/20; A24F 40/50

(52) U.S. Cl. CPC A24F 40/46; A24F 40/20; A24F 40/50

(57) ABSTRACT

An aerosol generating device includes an oscillating unit configured to generate a microwave, a resonance unit configured to accommodate an aerosol generating article and heat the aerosol generating article by applying an electric field due to microwave resonance to the aerosol generating article, and a processor configured to control an output of the oscillating unit such that a greatest electric field absorption region of the aerosol generating article is moved.

### TECHNICAL FIELD

The present disclosure relates to an aerosol generating device capable of heating an aerosol generating article through a dielectric heating method, and more particularly, to an aerosol generating device capable of moving a greatest electric field absorption region of an aerosol generating article.

### BACKGROUND ART

Recently, there has been an increasing demand for alternative methods for resolving problems of the general cigarettes. For example, there has been an increasing demand for a system for generating an aerosol by heating a cigarette (or an “aerosol generating article”) by using an aerosol generating device, rather than a method for generating an aerosol by burning a cigarette.

In addition, general aerosol generating devices heat an aerosol generating material through a resistance heating method, an induction heating method, or an ultrasonic heating method. In this regard, the general aerosol generating devices have problems in that a preheating speed is slow and heating is not performed uniformly compared to a dielectric heating method.

Also, some of the general aerosol generating devices use the dielectric heating method, which is only a microwave radiation method using an antenna, and thus, there is a problem in that the power transmission efficiency is significantly reduced.

### DISCLOSURE

### Technical Problem

The present disclosure provides an aerosol generating device capable of heating an aerosol generating article through a dielectric heating method using microwave resonance.

Technical tasks of the present disclosure are not limited to those described above, and other technical tasks may be inferred from the following examples.

### Technical Solution

According to an aspect of the present disclosure, an aerosol generating device includes an oscillating unit configured to generate a microwave, a resonance unit configured to accommodate an aerosol generating article and heat the aerosol generating article by applying an electric field due to microwave resonance to the aerosol generating article, and a processor configured to control an output of the oscillating unit such that a greatest electric field absorption region of the aerosol generating article is moved.

### Advantageous Effects

An aerosol generating device of the present disclosure heats a dielectric material through microwave resonance, and thus, there is an advantage of significantly increasing power transmission efficiency.

Also, the aerosol generating device heats an aerosol generating article through microwave resonance, the aerosol generating article may be quickly preheated.

Also, when the aerosol generating device heats an aerosol generating article through microwave resonance, power consumption may be significantly reduced.

Also, the aerosol generating device may provide a uniform taste of smoke throughout the entire heating section by moving the greatest absorption region of an electric field due to microwave resonance within an aerosol generating article.

Effects of the present disclosure are not limited to above descriptions, and other effects are included in the present specification.

### DESCRIPTION OF DRAWINGS

FIG. 1 is a perspective view of an aerosol generating device according to an embodiment.

FIG. 2 is an internal block diagram of an aerosol generating device according to an embodiment.

FIG. 3 is an internal block diagram of a dielectric heating unit of FIG. 2.

FIG. 4 is a perspective view of a heater assembly according to an embodiment.

FIG. 5 is a perspective view schematically illustrating a heater assembly according to an embodiment illustrated in FIG. 4.

FIG. 6 is a cross-sectional view of a heater assembly according to an embodiment illustrated in FIG. 4.

FIG. 7 is a perspective view schematically illustrating an electric field distribution of a heater assembly according to an embodiment illustrated in FIG. 4.

FIG. 8 is a perspective view schematically illustrating a heating density distribution of an aerosol generating article heated by a heater assembly according to an embodiment illustrated in FIG. 4.

FIG. 9 is an internal block diagram illustrating a method of controlling an output of an oscillating unit according to an embodiment.

FIG. 10 is a diagram illustrating a power profile for controlling an output of an oscillating unit according to an embodiment illustrated in FIG. 9.

FIG. 11 is a view illustrating a movement of a greatest electric field absorption region according to a power profile according to an embodiment illustrated in FIG. 10.

FIG. 12 is a flowchart illustrating an operating method of an aerosol generating device according to an embodiment.

### BEST MODE

According to an aspect, an aerosol generating device includes an oscillating unit configured to generate a microwave, a resonance unit configured to accommodate an aerosol generating article and heat the aerosol generating article by applying an electric field due to microwave resonance to the aerosol generating article, and a processor configured to control an output of the oscillating unit such that a greatest electric field absorption region of the aerosol generating article is moved.

Also, the resonance unit includes a first plate surrounding one region of the aerosol generating article; a second plate separated from the first plate in a circumferential direction of the aerosol generating article and surrounding another region of the aerosol generating article; and a connector configured to connect the first plate to the second plate, and the microwave is resonated by the first plate, the second plate, and the connector, and the aerosol generating article is heated by the electric field output from end portions of the first plate and the second plate.

Also, lengths of the first plate and the second plate are less than a length of a tobacco rod included in the aerosol generating article, the tobacco rod is arranged at a position protruding from the end portions of the first plate and the second plate in a direction toward an opening in which the aerosol generating article is accommodated, and the greatest electric field absorption region is generated in a preset region of the tobacco rod arranged in a direction of the end portions of the first plate and the second plate at beginning of heating.

Also, the processor controls the output of the oscillating unit such that the greatest electric field absorption region is moved in a longitudinal direction of the tobacco rod included in the aerosol generating article.

Also, the greatest electric field absorption region is moved within the tobacco rod in an opposite direction to a direction toward an opening in which the aerosol generating article is accommodated.

Also, the processor adjusts a magnitude of microwave power output from the oscillating unit according to a preset power profile such that the greatest electric field absorption region of the aerosol generating article is moved.

Also, the processor controls the oscillating unit to output microwave power of a first magnitude in a preheating section.

Also, when a smoking section starts after the preheating section, the processor controls the oscillation unit to output microwave power of a second magnitude that is less than the first magnitude, and as the smoking section progresses, the processor progressively increases the microwave power output from the oscillating unit such that the greatest electric field absorption region is moved.

Also, the processor tracks in real time a change in resonance frequency of the resonance unit due to exhaustion of a dielectric material included in the aerosol generating article, and adjusts an output frequency of microwave power output from the oscillating unit based on the change in the resonance frequency of the resonance unit.

Also, the processor independently controls a magnitude of the microwave power and the output frequency of the microwave power.

### MODE FOR INVENTION

Hereinafter, embodiments of the disclosure are described in detail with reference to the attached drawings, and regardless of the drawing symbols, identical or similar components are given the same reference numerals, and redundant descriptions thereof are omitted.

Suffixes “module”, “unit”, and “portion” used for components in the following description are given or used interchangeably only for the sake of convenience of describing the disclosure and do not have distinct meanings or functions in themselves.

Also, in describing the embodiments disclosed in the disclosure, when it is determined that detailed descriptions of the related known technologies may obscure the gist of the embodiments disclosed in the disclosure, the detailed descriptions are omitted. Also, the attached drawings are only for easy understanding of the embodiments disclosed in the disclosure, and the technical idea disclosed in the disclosure is not limited by the attached drawings and should be understood to include all changes, equivalents, and substitutes included in the idea and technical scope of the disclosure.

Terms including ordinal numbers, such as “first”, “second”, and so on, may be used to describe various components, but the components are not limited by the terms. The terms described above are used only for the purpose of distinguishing one component from another component.

When a component is described to be “connected” or “coupled” to another component, it should be understood that the component may be directly connected or coupled to another component and may be connected or coupled thereto with other components therebetween. In addition, when it is described that a component is “directly connected” or “directly coupled” to another component, it should be understood that there are no other components therebetween.

Singular expressions include plural expressions unless the context clearly dictates otherwise.

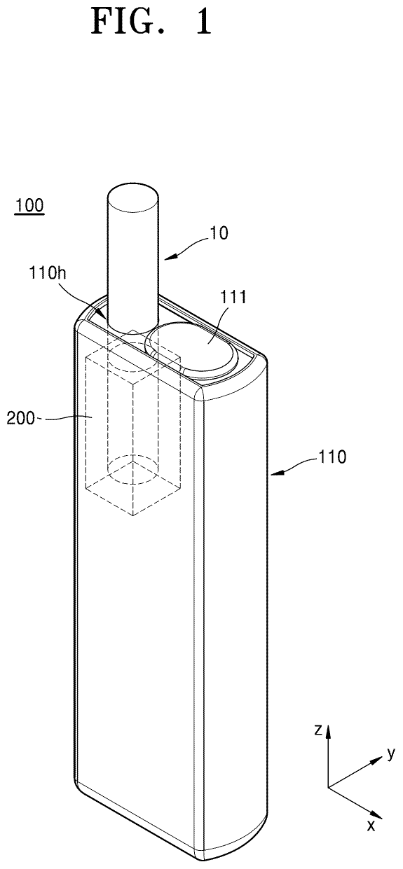

FIG. 1 is a perspective view of an aerosol generating device according to an embodiment.

Referring to FIG. 1, an aerosol generating device 100 according to an embodiment may include a housing 110, in which an aerosol generating article 10 may be accommodated, and a heater assembly 200 for heating the aerosol generating article 10 accommodated in the housing 110.

The housing 110 may form the entire appearance of the aerosol generating device 100, and components of the aerosol generating device 100 may be arranged in an internal space (or a “mounting space”) of the housing 110. For example, a heater assembly 200, a battery, a processor, and/or a sensor may be arranged in the internal space of the housing 110, but the components arranged in the internal space of the housing 110 are not limited thereto.

An insertion hole 110h may be formed in one region of the housing 110, and at least one region of an aerosol generating article 10 may be inserted into the housing 110 through the insertion hole 110h. For example, the insertion hole 110h may be formed in one region of an upper surface (for example, a surface facing the z direction) of the housing 110, but the position of the insertion hole 110h is not limited thereto. In another embodiment, the insertion hole 110h may also be formed in one region of a side surface (for example, a surface facing the x direction) of the housing 110.

The heater assembly 200 is arranged in the interior space of the housing 110 and may heat the aerosol generating article 10 inserted or accommodated in the housing 110 through the insertion hole 110h. For example, the heater assembly 200 may surround at least a part of the aerosol generating article 10 inserted or accommodated in the housing 110 to heat the aerosol generating article 10.

According to an embodiment, the heater assembly 200 may heat the aerosol generating article 10 by using a dielectric heating method. In the disclosure, the “dielectric heating method” means a method of heating a dielectric, which is a heating target, by using microwave resonance and/or an electric field (or a magnetic field) of the microwaves. The microwaves are used as an energy source for heating a heating target and generated by high-frequency power, and accordingly, the microwaves may be used interchangeably with microwave power below.

Electric charges or ions of a dielectric included in the aerosol generating article 10 may vibrate or rotate due to microwave resonance inside the heater assembly 200, and heat is generated in the dielectric due to the frictional heat generated while the electric charges or ions vibrate or rotate, and accordingly, the aerosol generating article 10 may be heated.

As the aerosol generating article 10 is heated by the heater assembly 200, an aerosol may be generated from the aerosol generating article 10. In the disclosure, an “aerosol” may mean gas particles generated by mixing air and vapor generated as the aerosol generating article 10 is heated.

The aerosol generated from the aerosol generating article 10 may pass through the aerosol generating article 10 or may be discharged to the outside of the aerosol generating device 100 through an empty space between the aerosol generating article 10 and the insertion hole 110h. A user may smoke by bringing their mouth into contact with a region of the aerosol generating article 10 exposed to the outside of the housing 110 and inhaling the aerosol discharged to the outside of the aerosol generating device 100.

The aerosol generating device 100 according to the embodiment may further include a cover 111 that is movably arranged in the housing 110 to open or close the insertion hole 110h. For example, the cover 111 may be slidably coupled to an upper surface of the housing 110 and may expose the insertion hole 110h to the outside of the aerosol generating device 100 or cover the insertion hole 110h such that the insertion hole 110h is not exposed to the outside of the aerosol generating device 100.

In one example, the cover 111 may expose the insertion hole 110h to the outside of the aerosol generating device 100 at a first position (or an “open position”). When the aerosol generating device 100 is exposed to the outside, the aerosol generating article 10 may be inserted into the housing 110 through the insertion hole 110h.

In another example, the cover 111 may cover the insertion hole 110h at a second position (or a “closed position”), and accordingly, the insertion hole 110h may be prevented from being exposed to the outside of the aerosol generating device 100. In this case, the cover 111 may prevent an external foreign material from being introduced into the heater assembly 200 through the insertion hole 110h when the aerosol generating device 100 is not in use.

Although FIG. 1 illustrates only the aerosol generating device 100 for heating the aerosol generating article 10 in a solid state, the aerosol generating device 100 is not limited to the illustrated embodiment.

An aerosol generating device according to another embodiment may also generate an aerosol by heating an aerosol generating material in a liquid or gel state instead of the aerosol generating article 10 in a solid state through the heater assembly 200.

An aerosol generating device according to another embodiment includes the heater assembly 200 for heating the aerosol generating article 10 and an aerosol generating material in a liquid or gel state, and may also include a cartridge (or a “vaporizer”) for heating the aerosol generating material. An aerosol generated from the aerosol generating material may move to the aerosol generating article 10 through an airflow passage connecting the cartridge to the aerosol generating article 10, be mixed with the aerosol generated from the aerosol generating article 10, and then pass through the aerosol generating article 10 to be transferred to a user.

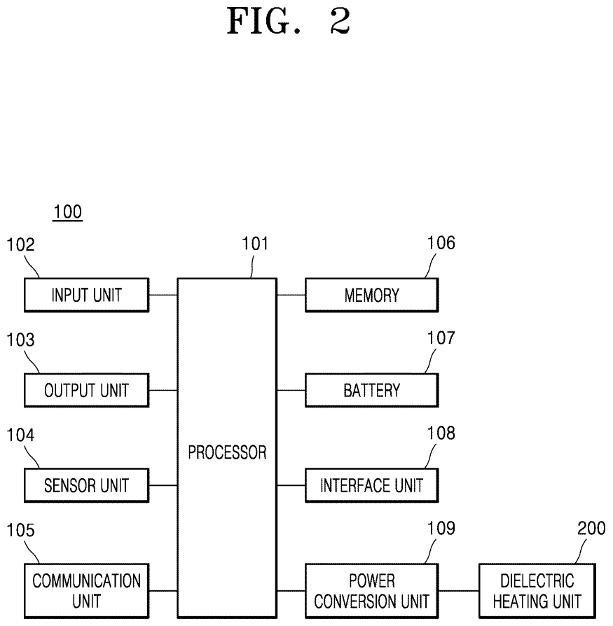

FIG. 2 is an internal block diagram of an aerosol generating device according to an embodiment.

Referring to FIG. 2, an aerosol generating device 100 may include an input unit 102, an output unit 103, a sensor unit 104, a communication unit 105, a memory 106, a battery 107, an interface unit 108, a power conversion unit 109, and a dielectric heating unit 200.

The input unit 102 may receive a user input. For example, the input unit 102 may be provided as a single pressure push button. In another example, the input unit 102 may be a touch panel including at least one touch sensor. The input unit 102 may transmit an input signal to the processor 101. The processor 101 may supply power to the dielectric heating unit 200 based on user input, or control the output unit 103 such that a user notification is output.

The output unit 103 may output information on a state of the aerosol generating device 100. The output unit 103 may output charging and discharging states of the battery 107, a heating state of the dielectric heating unit 200, an insertion state of the aerosol generating article 10, and error information of the aerosol generating device 100. To this end, the output unit 103 may include a display, a haptic motor, and an audio output unit.

The sensor unit 104 may detect a state of the aerosol generating device 100 or an ambient state of the aerosol generating device 100 and transmit the detected information to the processor 101. The processor 101 may control the aerosol generating device 100 to perform various functions, such as heating control of the dielectric heating unit 200, smoking restriction, determining whether the aerosol generating article 10 is inserted, and displaying a notification based on the detected information.

The sensor unit 104 may include a temperature sensor, a puff sensor, and an insertion detection sensor.

The temperature sensor may detect the temperature inside the dielectric heating unit 200 in a non-contact manner, or may directly obtain the temperature of a resonator by coming into contact with the dielectric heating unit 200. According to an embodiment, the temperature sensor may also detect the temperature of the aerosol generating article 10. Also, the temperature sensor may be arranged adjacent to the battery 107 to obtain the temperature of the battery 107. The processor 101 may control the power supplied to the dielectric heating unit 200 based on temperature information of the temperature sensor.

The puff sensor may detect a user's puff. The puff sensor may detect a user's puff based on at least one of a temperature change, a flow amount change, a power change, and a pressure change. The processor 101 may control the power supplied to the dielectric heating unit 200 based on puff information of the puff sensor. For example, the processor 101 may count the number of puffs and disconnect the power supplied to the dielectric heating unit 200 when the number of puffs reaches a preset maximum number of puffs. In another example, the processor 101 may disconnect the power supplied to the dielectric heating unit 200 when no puff is detected for a preset time or more.

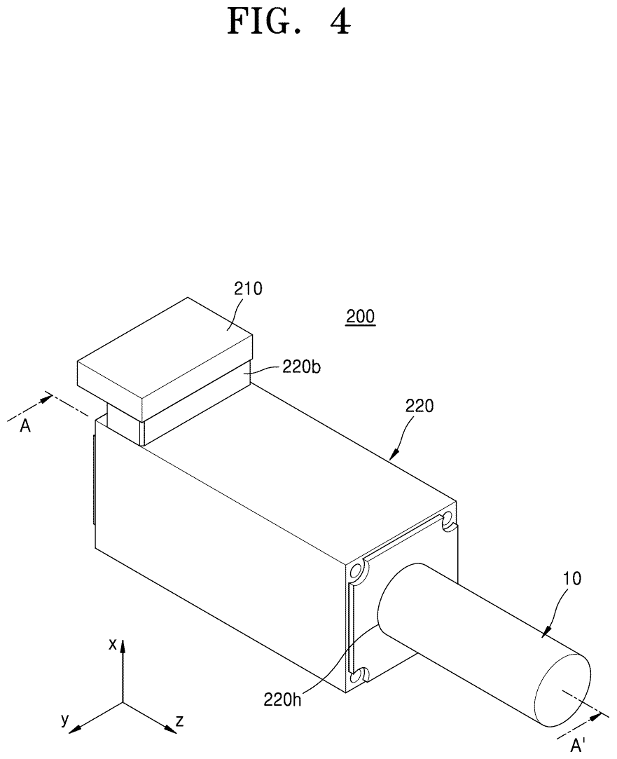

The insertion detection sensor may be arranged inside an accommodation space 220h (see FIG. 4) or adjacent to the accommodation space 220h and detect insertion and removal of the aerosol generating article 10 accommodated in the insertion hole 110h. For example, the insertion detection sensor may include an inductive sensor and/or a capacitance sensor. The processor 101 may supply power to the dielectric heating unit 200 when the aerosol generating article 10 is inserted into the insertion hole 110h.

According to the embodiment, the sensor unit 104 may further include a reuse detection sensor, a motion detection sensor, a humidity sensor, a barometric pressure sensor, a magnetic sensor, a cover removal detection sensor, a position sensor (or a global positioning sensor (GPS)), a proximity sensor, and so on. Functions of the respective sensor may be intuitively inferred from names of the respective sensors, and accordingly, detailed descriptions thereof are omitted.

The communication unit 105 may include at least one communication module for communicating with an external electronic device. The processor 101 may control the communication unit 105 such that information on the aerosol generating device 100 is transmitted to an external electronic device. Also, the processor 101 may receive information from the external electronic device through the communication unit 105 and control components included in the aerosol generating device 100. For example, the information transmitted between the communication unit 105 and the external electronic device may include user authentication information, firmware update information, user smoking pattern information, and so on.

The memory 106 is hardware that stores various types of data processed by the aerosol generating device 100, and may store the data processed by the processor 101 and the data to be processed by the processor 101. For example, the memory 106 may store operation times of the aerosol generating device 100, the greatest number of puffs, the current number of puffs, at least one temperature profile, data on a user's smoking pattern, and so on.

The battery 107 may supply power to the dielectric heating unit 200 such that the aerosol generating article 10 may be heated. Also, the battery 107 may supply power required for operations of the other components provided in the aerosol generating device 100. The battery 107 may be a rechargeable battery or a detachable and removable battery.

The interface unit 108 may include a connection terminal that may be physically connected to an external electronic device. The connection terminal may include at least one or a combination of a high-definition multimedia interface (HDMI) connector, a Universal Serial Bus (USB) connector, a secure digital (SD) card connector, or an audio connector (for example, a headphones connector). The interface unit 108 may transmit and receive information to and from an external electronic device through the connection terminal, or may charge power.

The power conversion unit 109 may convert direct current (DC) power supplied from the battery 107 into alternating current (AC) power. Also, the power conversion unit 109 may provide the AC power to the dielectric heating unit 200. The power conversion unit 109 may be an inverter including at least one switching element, and the processor 101 may control turning the switching element included in the power conversion unit 109 on or off to convert DC power into AC power. The power conversion unit 109 may be configured by a full bridge or a half bridge.

The dielectric heating unit 200 may heat the aerosol generating article 10 by using a dielectric heating method. The dielectric heating unit 200 may correspond to the heater assembly 200 of FIG. 1.

The dielectric heating unit 200 may heat the aerosol generating article 10 by using microwaves and/or an electric field of the microwaves (hereinafter, referred to as microwaves or microwave power when there is no need for distinction). A heating method of the dielectric heating unit 200 may be a method of heating a heating target by forming microwaves in a resonance structure, rather than a method of radiating microwaves by using an antenna. The resonance structure is described below with reference to FIG. 4 and below.

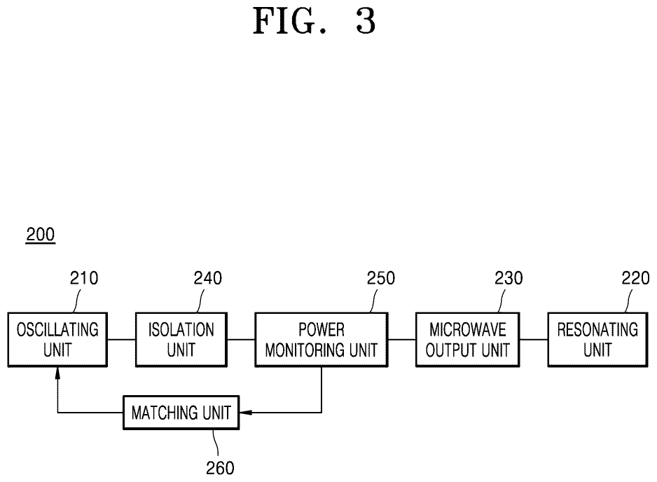

The dielectric heating unit 200 may output high-frequency microwaves to a resonance unit 220 (see FIG. 3). The microwaves may be power in an industrial scientific and medical (ISM) equipment band allowed for heating but are not limited thereto. The resonance unit 220 may be designed by considering wavelengths of the microwaves such that the microwaves may resonate within the resonance unit 220.

The aerosol generating article 10 may be inserted into the resonance unit 220, and a dielectric material in the aerosol generating article 10 may be heated by the resonance unit 220. For example, the aerosol generating article 10 may include a polar material, and molecules in the polar material may be polarized in the resonance unit 220. The molecules may vibrate or rotate due to a polarization phenomenon, and the aerosol generating article 10 may be heated by frictional heat generated during the vibration or rotation of the molecules. The dielectric heating unit 200 is described in more detail below with reference to FIG. 3.

The processor 101 may control all operations of the aerosol generating device 100. The processor 101 may be implemented by an array of a plurality of logic gates, or may be implemented by a combination of a general-purpose microprocessor and a memory storing a program that may be executed by the general-purpose microprocessor. Also, the processor 101 may be implemented by another type of hardware.

The processor 101 may control the DC power supplied from the battery 107 to the power conversion unit 109 according to the power demand of the dielectric heating unit 200, and/or the AC power supplied from the power conversion unit 109 to the dielectric heating unit 200. In one embodiment, the aerosol generating device 100 may include a converter that boosts or lowers DC power, and the processor 101 may adjust a level of the DC power by controlling the converter. Also, the processor 101 may control the AC power supplied to the dielectric heating unit 200 by adjusting a switching frequency and duty ratio of a switching element included in the power conversion unit 109.

The processor 101 may control a heating temperature of the aerosol generating article 10 by controlling microwave power of the dielectric heating unit 200 and a resonance frequency of the dielectric heating unit 200. Therefore, an oscillating unit 210, an isolation unit 240, a power monitoring unit 250, and a matching unit 260 illustrated in FIG. 3 and described below may also be components of the processor 101.

The processor 101 may control microwave power of the dielectric heating unit 200 based on temperature profile information stored in the memory 106. That is, the temperature profile may include information on a target temperature of the dielectric heating unit 200 over time, and the processor 101 may control the microwave power of the dielectric heating unit 200 over time.

The processor 101 may adjust the frequency of a microwave such that the resonance frequency of the dielectric heating unit 200 is constant. The processor 101 may track the change in resonance frequency of the dielectric heating unit 200 in real time according to the heating of a heating target and control the dielectric heating unit 200 such that the microwave frequency according to the changed resonance frequency is output. That is, the processor 101 may change the microwave frequency in real time regardless of the pre-stored temperature profile.

FIG. 3 is an internal block diagram of the dielectric heating unit 200 of FIG. 2.

Referring to FIG. 3, the dielectric heating unit 200 may include the oscillating unit 210, the isolation unit 240, the power monitoring unit 250, the matching unit 260, a microwave output unit 230, and a resonance unit 220.

The oscillating unit 210 may receive AC power from the power conversion unit 109 and generate high-frequency microwave power. According to an embodiment, the power conversion unit 109 may be included in the oscillating unit 210. The microwave power may be selected from among 915 MHz, 2.45 GHz, and 5.8 GHz frequency bands included in an ISM band.

The oscillating unit 210 may include a solid-state-based RF generating device and generate microwave power by using the solid-state-based RF generating device. The solid-state-based RF generating device may be implemented by a semiconductor. When the oscillating unit 210 is implemented by a semiconductor, there is an advantage in that the dielectric heating unit 200 is reduced in size and increases in lifespan.

The oscillating unit 210 may output microwave power to the resonance unit 220. The oscillating unit 210 may include a power amplifier that increases or decreases the microwave power, and the power amplifier may adjust the microwave power under the control of the processor 101. For example, the power amplifier may decrease or increase an amplitude of a microwave. By adjusting the amplitude of the microwave, the microwave power may be adjusted.

The processor 101 may adjust the microwave power output from the oscillating unit 210 based on a pre-stored power profile. For example, the power profile may include target power information according to a preheating period and a smoking period, and the oscillating unit 210 may supply microwave power as first power in the preheating period and supply microwave power as second power that is less than the first power in the smoking period.

The isolation unit 240 may block the microwave power input from the resonance unit 220 to the oscillating unit 210. Most of the microwave power output from the oscillating unit 210 is absorbed by a heating target, but depending on heating patterns of the heating target, a part of the microwave power may be reflected by the heating target and transmitted again to the oscillating unit 210. This is because the impedance viewed from the oscillating unit 210 toward the resonance unit 220 changes due to exhaustion of polar molecules according to the heating of the heating target. The meaning of “impedance viewed from the oscillating unit 210 toward the resonance unit 220 changes” may be the same as the meaning of “a resonance frequency of the resonance unit 220 changes”. When the microwave power reflected from the resonance unit 220 is input to the oscillating unit 210, the oscillating unit 210 may fail, and the expected output performance may not be achieved. The isolation unit 240 may absorb the microwave power reflected from the resonance unit 220 by guiding the microwave power in a preset direction without returning the microwave power to the oscillating unit 210. Due to this, the isolation unit 240 may include a circulator and a dummy load.

The power monitoring unit 250 may monitor both the microwave power output from the oscillating unit 210 and the microwave power reflected from the resonance unit 220. The power monitoring unit 250 may transmit information on the microwave power and the reflected microwave power to the matching unit 260.

The matching unit 260 may match the impedance of the resonance unit 220 viewed from the oscillating unit 210 to the impedance of the oscillating unit 210 viewed from the resonance unit 220 such that the reflected microwave power is reduced. Impedance matching may have the same meaning as matching the frequency of the oscillating unit 210 to the resonance frequency of the resonance unit 220. Therefore, the matching unit 260 may vary the frequency of the oscillating unit 210 to match the impedance of the matching unit 260. That is, the matching unit 260 may adjust the frequency of the microwave power output from the oscillating unit 210 such that the reflected microwave power is reduced. The impedance matching of the matching unit 260 may be performed in real time regardless of a temperature profile.

In addition, the oscillating unit 210, the isolation unit 240, the power monitoring unit 250, and the matching unit 260 described above may be separate components from the microwave output unit 230 and resonance unit 220 described below, and may be implemented as a microwave source in the form of a chip. Also, according to an embodiment, the oscillating unit 210, the isolation unit 240, the power monitoring unit 250, and the matching unit 260 described above may also be implemented as a part of the processor 101.

The microwave output unit 230 may cause microwave power to be input to the resonance unit 220 and may correspond to a coupler of FIG. 4 and below. The microwave output unit 230 may be implemented in the form of an SMA, SMB, MCX, or MMCX connector. The microwave output unit 230 may connect a chip-shaped microwave source to the resonance unit 220, and accordingly, the microwave power generated by the microwave source may be transmitted to the resonance unit 220.

The resonance unit 220 may heat a heating target by forming microwaves within a resonance structure. The resonance unit 220 may include an accommodation space in which the aerosol generating article 10 is accommodated, and the aerosol generating article 10 may be exposed to microwaves to be dielectrically heated. For example, the aerosol generating article 10 may include a polar material, and molecules in the polar material may be polarized by the microwaves within the resonance unit 220. The molecules may vibrate or rotate due to a polarization phenomenon, and the aerosol generating article 10 may be heated by frictional heat generated during the vibration or rotation of the molecules.

The resonance unit 220 may include at least one internal conductor such that microwaves may resonate, and the microwaves may resonate in the resonance unit 220 according to an arrangement, a thickness, a length, and so on of the internal conductor.

The resonance unit 220 may be designed by considering wavelengths of microwaves such that the microwaves may resonate in the resonance unit 220. In order for microwaves to resonate in the resonance unit 220, a closed end/short end having a closed cross-section and an open end having at least one region of a cross-section opened in an opposite direction to the closed end are required. Also, a length between the closed end/short end and the open end has to be set to an integer multiple of a quarter wavelength of a microwave. The resonance unit 220 according to the disclosure selects a quarter wavelength of a microwave to reduce a size of a device. That is, the length between the closed end/short end and the open end of the resonance unit 220 may be set to a quarter wavelength of a microwave.

The resonance unit 220 may include a dielectric accommodation space. The dielectric accommodation space 226 is different from the accommodation space of the aerosol generating article 10, and a material that may change all resonance frequencies of the resonance unit 220 and reduce a size of the resonance unit 220 is provided in the dielectric accommodation space 226. In one embodiment, a dielectric with a low microwave absorbance may be accommodated in the dielectric accommodation space 226. This is to prevent the phenomenon in which energy that has to be transferred to a heating target is transferred to a dielectric and the dielectric itself is heated. A microwave absorbance may be represented as a loss tangent, which is a ratio of a real part a complex dielectric constant to an imaginary part of the complex dielectric constant. In one embodiment, a dielectric with a loss tangent less than a preset size may be accommodated in the dielectric accommodation space 227, and the preset size may be 1/100. For example, the dielectric may be at least one of quartz, tetrafluoroethylene, and aluminum oxide, or a combination thereof but is not limited thereto.

FIG. 4 is a perspective view of a heater assembly according to an embodiment.

Referring to FIG. 4, a heater assembly 200 according to an embodiment may include an oscillating unit 210 and a resonance unit 220. FIG. 4 may be an example of the heater assembly 200 and the dielectric heating unit 200 described above, and redundant descriptions thereof are omitted below.

The oscillating unit 210 may generate microwaves of a designated frequency band when power is supplied to the oscillating unit 210. The microwaves generated by the oscillating unit 210 may be transmitted to the resonance unit 220 through a coupler (not illustrated).

The resonance unit 220 may include an accommodation space 220h for accommodating at least one region of the aerosol generating article 10 and may heat the aerosol generating article 10 in a dielectric heating manner by resonating the microwaves generated by the oscillating unit 210. For example, electric charges of glycerin included in the aerosol generating article 10 may vibrate or rotate according to a microwave resonance, and the glycerin may generate heat due to the frictional heat generated when the electric charges vibrate or rotate, and accordingly, the aerosol generating article 10 may be heated.

According to an embodiment, the resonance unit 220 may be formed of a material with a low microwave absorption rate to prevent the microwave generated by the oscillating unit 210 from being absorbed by the resonance unit 220.

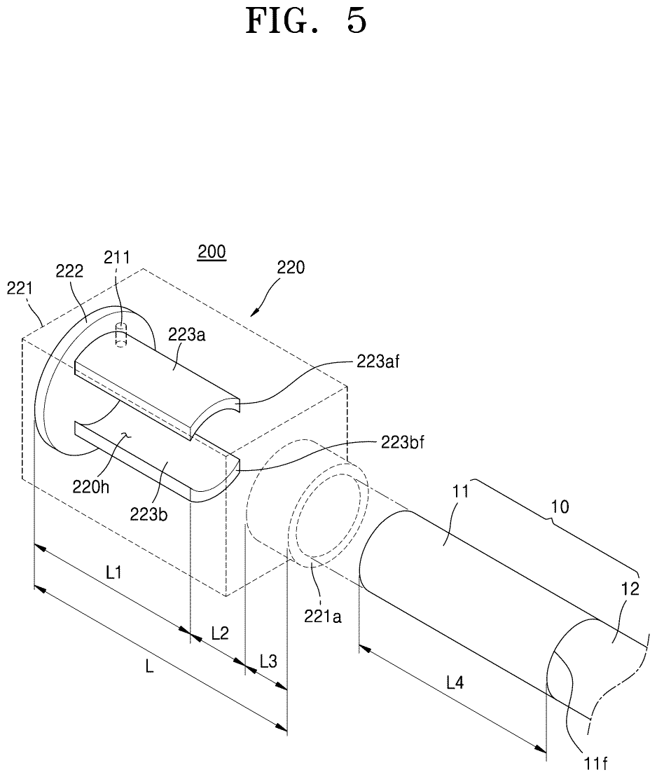

Hereinafter, a structure of the resonance unit 220 of the heater assembly 200 is described in detail with reference to FIG. 5.

FIG. 5 is a perspective view schematically illustrating a heater assembly according to another embodiment illustrated in FIG. 4.

Referring to FIG. 5, the heater assembly 200 according to the embodiment illustrated in FIG. 5 may include a resonance unit 220 that generates microwave resonance, and a coupler 211 that supplies microwaves to the resonance unit 220.

The resonance unit 220 may include a case 221, a first plate 223a, a second plate 223b, and a connector 222 that connects the first plate 223a and the second plate 223b to the case 221.

The coupler 211 may supply microwaves to at least one of the first plate 223a and the second plate 223b to generate microwave resonance in the resonance unit 220.

The resonance unit 220 may surround at least one region of the aerosol generating article 10 inserted into an aerosol generating device. The coupler 211 may supply the microwaves generated by an oscillating unit (not illustrated) to the resonance unit 220. When microwaves are supplied to the resonance unit 220, microwave resonance occurs in the resonance unit 220, and accordingly, the resonance unit 220 may heat the aerosol generating article 10. For example, dielectrics included in the aerosol generating article 10 may be heated by an electric field generated inside the resonance unit 220 by microwaves, and the aerosol generating article 10 may be heated by the heat generated by the dielectrics.

The case 221 of the resonance unit 220 functions as an “outer conductor”. The case 221 has a hollow shape in which the inside of the case 221 is empty, and accordingly, components of the resonance unit 220 may be arranged inside the case 221.

The case 221 may include an accommodation space 220h in which the aerosol generating article 10 may be accommodated, and an opening 221a into which the aerosol generating article 10 may be inserted. The opening 221a may be connected to the accommodation space 220h. The opening 221a is opened toward the outside of the case 221, and accordingly, the accommodation space 220h may be connected to the outside through the opening 221a. Therefore, the aerosol generating article 10 may be inserted into the accommodation space 220h of the case 221 through the opening 221a of the case 221.

Although FIG. 5 illustrates that the case 221 has a square cross-sectional shape, the shape of the case 221 may be changed to various shapes. For example, a structure of the case 221 may have one of various cross-sectional shapes, such as a rectangle, an ellipse, or a circle. The case 221 may extend in one direction.

The first plate 223a and the second plate 223b that may function as an “internal conductor” of the resonance unit 220 may be arranged inside the case 221.

The first plate 223a and the second plate 223b may be arranged to be separated from each other in a circumferential direction of the aerosol generating article 10 accommodated in the accommodation space 220h. The first plate 223a surrounds one region of the aerosol generating article 10, and the second plate 223b surrounds another region of the aerosol generating article 10.

The first plate 223a and the second plate 223b may be connected to the case 221 through the connector 222. Also, one end of the first plate 223a may be connected to one end of the second plate 223b by the connector 222. Therefore, closed ends may be formed at ends of the first plate 223a and the second plate 223b by the connector 222.

An end 223af of the first plate 223a and an end 223bf of the second plate 223b may be separated from each other and be opened. Because the ends 223af and 223bf are separated from each other, open ends may be formed at the other ends of the first plate 223a and the second plate 223b.

A resonator assembly may be completed by connecting the first plate 223a and the second plate 223b to the connector 222. A shape of a cross-section taken along a longitudinal direction of the resonator assembly may include a “horseshoe-shape”.

The first plate 223a and the second plate 223b may extend toward a longitudinal direction of the aerosol generating article 10. At least a part of each of the first plate 223a and the second plate 223b may be curved to protrude outwardly from the center of the longitudinal direction of the aerosol generating article 10.

For example, when the aerosol generating article 10 has a cylindrical shape, the first plate 223a and the second plate 223b may be curved in a circumferential direction along an outer circumferential surface of the aerosol generating article 10. A radius of curvature of a cross-section of each of the first plate 223a and the second plate 223b may be equal to a radius of curvature of the aerosol generating article 10. The radius of curvature of the cross-section of each of the first plate 223a and the second plate 223b may be variously modified. For example, the radius of curvature of the cross-section of each of the first plate 223a and the second plate 223b may be greater or less than the radius of curvature of the aerosol generating article 10.

According to the structure in which the first plate 223a and the second plate 223b are curved in a circumferential direction along an outer circumferential surface of the aerosol generating article 10, a more uniform electric field is formed in the resonance unit 220, and accordingly, the heater assembly 200 may uniformly heat the aerosol generating article 10.

The open ends of the ends 223af and 223bf of the first plate 223a and the second plate 223b may face the opening 221a of the case 221. The opening 221a of the case 221 may be separated from end portions of the ends 223af and 223bf of the first plate 223a and the second plate 223b to be far away therefrom.

The open ends of the ends 223af and 223bf of the first plate 223a and the second plate 223b may be aligned with respect to the opening 221a of the case 221. Therefore, when the aerosol generating article 10 is inserted into the accommodation space 220h through the opening 221a of the case 221, a part of the aerosol generating article 10 which is placed in the accommodation space 220h may be surrounded by the first plate 223a and the second plate 223b.

The first plate 223a and the second plate 223b are arranged on an opposite side of the center of a longitudinal direction of the aerosol generating article 10. The embodiments are not limited to the number of the first plate 223a and the second plate 223b, and the number of the first plate 223a and the second plate 223b may be, for example, three, four, or more.

The first plate 223a and the second plate 223b may be arranged to be symmetrical to a central axis of a longitudinal direction of the aerosol generating article 10, that is, a direction in which the aerosol generating article 10 extends.

At least one of the first plate 223a and the second plate 223b may be in contact with the coupler 211 connected to an oscillating unit (not illustrated). The resonance unit 220 may include a case 221, a plurality of plates 223a and 223b, and a connector 222 that connects the first plate 223a and the second plate 223b to the case 221. When the microwave is transmitted to the first plate 223a through the coupler 211, microwave resonance may be formed between the first plate 223a and the second plate 223b. Also, microwave resonance may be formed between the first plate 223a and an upper plate of the case 221 and between the second plate 223b and a lower plate of the case 221. Therefore, an electric field may be generated between the first and second plates 223a and 223b and the connector 222, between the first plate 223a and the upper plate of the case 221, and between the second plate 223b and the lower plate of the case 221.

The coupler 211 may pass through the case 221, and accordingly, one end of the coupler 211 may be in contact with an oscillating unit (not illustrated), and the other end of the coupler 211 may be in contact with one region of the first plate 223a. As the microwaves generated by the oscillating unit (not illustrated) are transmitted to the first plate 223a and the second plate 223b and the connector 222 through the coupler 211, an electric field may be generated inside an assembly of the first plate 223a and the second plate 223b and the connector 222.

Also, according to a structure of the resonance unit 220 of the heater assembly 200, a triple resonance mode may be formed in the resonance unit 220. Resonance of a transverse electric & magnetic (TEM) mode of microwaves is formed between the first plate 223a and the second plate 223b. Also, resonances of the TEM mode different from the resonance formed between the first plate 223a and the second plate 223b may be formed respectively between the first plate 223a and an upper plate of the case 221 and between the second plate 223b and a lower plate of the case 221. The resonance unit 220 of FIG. 5 enables TEM mode resonance formed by the first plate 223a and the second plate 223b, and accordingly, the resonance unit 220 may be manufactured to have a smaller size than the cylindrical resonator of the related art which only enables transverse electric (TE) resonance and transverse magnetic (TM) mode.

As triple resonance is generated in the resonance unit 220 of the heater assembly 200, the aerosol generating article 10 may be heated more effectively and uniformly.

The resonance unit 220 according to the embodiment described above may include a closed end/short end of which cross-section is closed to have a quarter length λ/4 of a wavelength λ of a microwave, and an open end of which cross-section is in an opposite direction to the closed end/short end and at least one region is opened.

In FIG. 5, a region of one end of the resonance unit 220 corresponding to a left region forms a closed end/short end closed by a structure in which one end of each of the first plate 223a and the second plate 223b and the connector 222 are connected to the case 221. In FIG. 5, a region of the other end of the resonance unit 220 corresponding to a right region forms an open end by opening the opening 221a of the case 221 to the outside. With the structure of the resonance unit 220, the resonance unit 220 may operate as a resonator having a quarter wavelength of a microwave.

According to a resonance structure of the resonance unit 220 described above, an electric field may not be transferred to an external region of the resonance unit 220. Therefore, the heater assembly 200 may prevent an electric field from leaking to the outside of the heater assembly 200 even without a separate shielding member for shielding the electric field.

The aerosol generating article 10 inserted into the accommodation space 220h of the case 221 may be surrounded by the first plate 223a and the second plate 223b to be heated by a dielectric heating method. For example, a part including a medium of the aerosol generating article 10 inserted into the accommodation space 220h of the case 221 may be arranged in a space between the first plate 223a and the second plate 223b. The aerosol generating article 10 may be heated when a dielectric included in the aerosol generating article 10 is heated by an electric field generated in a space between the first plate 223a and the second plate 223b.

Also, a secondary heating may be performed on the aerosol generating article 10 by the electric field due to the resonance mode formed between the first plate 223a and the upper plate of the case 221 and between the second plate 223b and the lower plate of the case 221.

According to one embodiment, the aerosol generating article 10 may include a tobacco rod 11 and a filter rod 12.

The tobacco rod 11 includes an aerosol generating material and may be manufactured as a sheet or strand or as tobacco cut sheets cut into small pieces. For example, the aerosol generating material may include at least one of glycerin, propylene glycol, ethylene glycol, dipropylene glycol, diethylene glycol, triethylene glycol, tetraethylene glycol, and oleyl alcohol but is not limited thereto. Also, the tobacco rod 11 may include another additive, such as a flavoring agent, a humectant, and/or organic acid. Also, a flavoring liquid, such as menthol or a humectant, may be added to the tobacco rod 11 by being sprayed onto the tobacco rod 11.

The filter rod 12 may be a cellulose acetate filter. In addition, there is no limitation on a shape of the filter rod 12. For example, the filter rod 12 may be a cylindrical rod or a tube-type rod having a hollow portion therein. Also, the filter rod 12 may be a recessed rod. When the filter rod 12 includes a plurality of segments, at least one of the plurality of segments may be made in a different shape.

At least a part of the aerosol generating material (for example, glycerin) included in the aerosol generating article 10 may be a dielectric having polarity in an electric field, and at least a part of the aerosol generating material may generate heat through a dielectric heating manner to heat the aerosol generating article 10.

When the aerosol generating article 10 is inserted into the resonance unit 220 through the accommodation space 220h, the tobacco rod 11 of the aerosol generating article 10 may be placed between the first plate 223a and the second plate 223b.

A length L4 of the tobacco rod 11 may be greater than a lengths L1 of each of the first plate 223a and the second plate 223b. Therefore, a front end 11f of the tobacco rod 11 in contact with the filter rod 12 may be placed at a position that protrudes more than the other end 223af of the first plate 223a and the other end 223bf of the second plate 223b in a direction toward the opening 221a of the case 221.

A resonance peak may be formed at the other end of each of the first plate 223a and the second plate 223b that operate as resonators, and accordingly, a stronger electric field may be generated compared to other regions. When the aerosol generating article 10 is inserted into the heater assembly 200, the tobacco rod 11 including a dielectric that may generate heat by an electric field may be arranged to correspond to a region where an electric field is strongest, and accordingly, heating efficiency (or “dielectric heating efficiency”) of the heater assembly 200 may be increased.

Referring to FIG. 5, the length L1 of each of the first plate 223a and the second plate 223b may be less than a length L1+L2 of an internal space of the case 221. Therefore, the other ends of the first plate 223a and the second plate 223b may be placed inside the case 221 rather than the opening 221a. That is, the other ends of the first plate 223a and the second plate 223b may be separated from a rear end of the opening 221a by a distance L2.

A length from the rear end of the opening 221a where the opening 221a is connected to the case 221 to a front end of the opening 221a where the opening 221a is opened may be L3. A total length of the case 221 in the longitudinal direction of the case 221 may be L. An entire length L of the case 221 may be determined by the sum of the length L1 of each of the first plate 223a and the second plate 223b, the length L2 which is a separated distance between the rear end of the opening 221a and the first and second plates 223a and 223b, and the length L3 of a protrusion of the opening 221a from the case 221.

In order to prevent leakage of microwaves, the front end of the opening 221a in which the opening 221a is opened is placed at a position in which the opening 221a protrudes from the case 221 by the length of L3. As the opening 221a of the case 221 protrudes from the case 221, the opening 221a may function to prevent microwaves inside the case 221 of the resonance unit 220 from leaking to the outside of the case 221.

The resonance unit 220 may further include a dielectric accommodation space 227 for accommodating a dielectric. The dielectric accommodation space 227 may be formed in a free space between the case 221 and the first and second plates 223a and 223b. A dielectric with a low microwave absorbance may be accommodated in the dielectric accommodation space 227.

As the heater assembly 200 provides a dielectric inside the dielectric accommodation space 227, the entire size of the resonance unit 220 may be reduced, and an electric field at the same level as the electric field generated by the resonance unit that does not include a dielectric may be generated. That is, a mounting space of the resonance unit 220 in an aerosol generating device may be reduced by reducing a size of the resonance unit 220 through a dielectric arranged inside the dielectric accommodation space 227, and as a result, the aerosol generating device may be miniaturized.

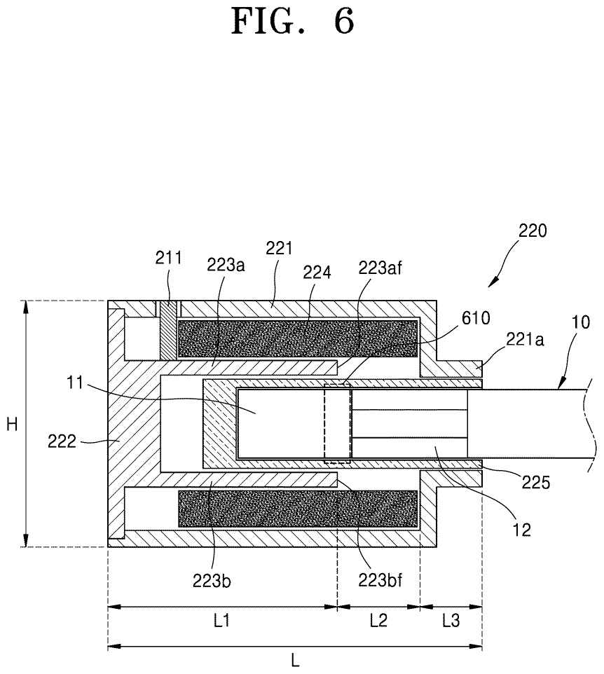

FIG. 6 is a cross-sectional view of a heater assembly according to the embodiment illustrated in FIG. 4.

Referring to FIG. 6, when the aerosol generating article 10 is inserted into a support tube 225 of the resonance unit 220, the tobacco rod 11 of the aerosol generating article 10 may be placed between the first plate 223a and the second plate 223b. a closed surface of one end of the support tube 225 supports the left end portion of the tobacco rod 11, and accordingly, a movement of the aerosol generating article 10 toward the left may be limited.

The length L1 of the first plate 223a and the second plate 223b may be set to be less than a length L1+L2 of an internal space of the case 221. Therefore, the other ends of the first plate 223a and the second plate 223b may be placed at positions separated from an opening 221a in the inside of the case 221. That is, the other ends of the first plate 223a and the second plate 223b may be separated by a distance of L2 from a rear end of the opening 221a.

A length of the opening 221a protruding from the case 221 may be L3. The total length of the case 221 in a longitudinal direction of the case 221 may be L. The total length L of the case 221 may be determined in the range of 25 mm to 35 mm, and the total length L of the case 221 of FIG. 6 is about 29 mm. In order to prevent leakage of microwaves, the length L3 of the opening 221 a may be greater than or equal to 5 mm.

A height H of the case 221 in a direction transverse to the longitudinal direction of the case 221 may be determined in the range of 13 to 25 mm, and the height H of the case 221 of FIG. 6 is about 16 mm.

A front end portion of a dielectric 224 arranged inside the resonance unit 220 may protrude more than the other ends of the first plate 223a and the second plate 223b toward the longitudinal direction of the case 221. In FIG. 6, a front end portion of the dielectric 224 may be in contact with an inner surface of the case 221. The length L2, by which the front end portion of the dielectric 224 protrudes more than the other ends of the first plate 223a and the second plate 223b, may be changed. Therefore, the front end portion of the dielectric 224 protrudes more than the other ends of the first plate 223a and the second plate 223b and may be separated from an internal surface of the case 221 so as not to be in contact with the internal surface of the case 221.

At least a part of the first plate 223a among the first plate 223a and the second plate 223b may be in contact with the coupler 211. A position where the coupler 211 in contact with the first plate 223a may be determined as a position closer to the connector 222 than to the opening 221a in a section from the opening 221a to the connector 222.

When a microwave is transmitted to the first plate 223a through the coupler 211, the microwave resonance is formed between the first plate 223a and the second plate 223b. Also, microwave resonances are respectively formed between the first plate 223a and an upper plate of the case 221 and between the second plate 223b and a lower plate of the case 221. Therefore, electric fields may be respectively generated between the first and second plates 223a and 223b and the connector 222, between the first plate 223a and the upper plate of the case 221, and between the second plate 223b and the lower plate of the case 221. In particular, resonance peaks are formed at an end portion 223af of the first plate 223a and an end portion 223bf of the second plate 223b that operate as a resonator, and thus, a stronger electric field may be generated in the end portions 223af and 223bf compared to other regions.

In addition, a front end of the tobacco rod 11 in contact with the filter rod 12 is at a position that protrudes more than the other end 223af of the first plate 223a and the other end 223bf of the second plate 223b in a direction toward the opening 221a of the case 221. Accordingly, a greatest electric field absorption region 610 may be arranged on the tobacco rod 11 arranged in a direction of the end portion 223af of the first plate 223a and the other end portion 223bf of the second plate 223b at the beginning of heating. The greatest electric field absorption region 610 may increase or decrease depending on outputs of the oscillating unit 210. Also, the beginning of heating may mean a period of time from the start of a smoking section to a point in time when a preset time elapses.

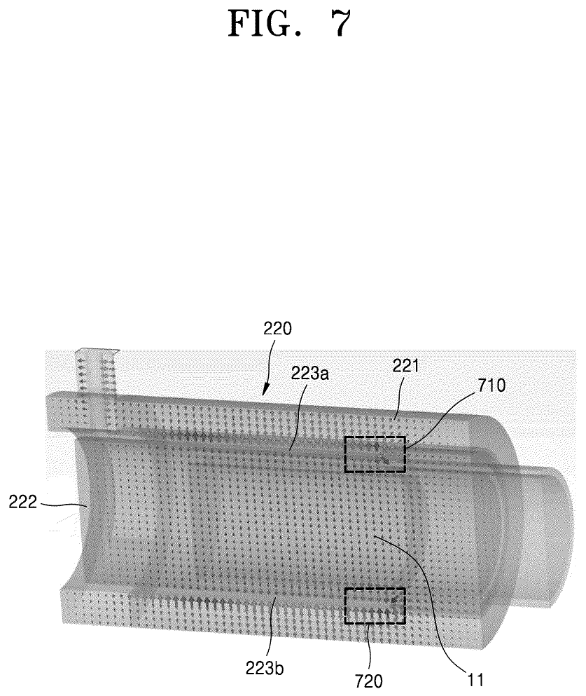

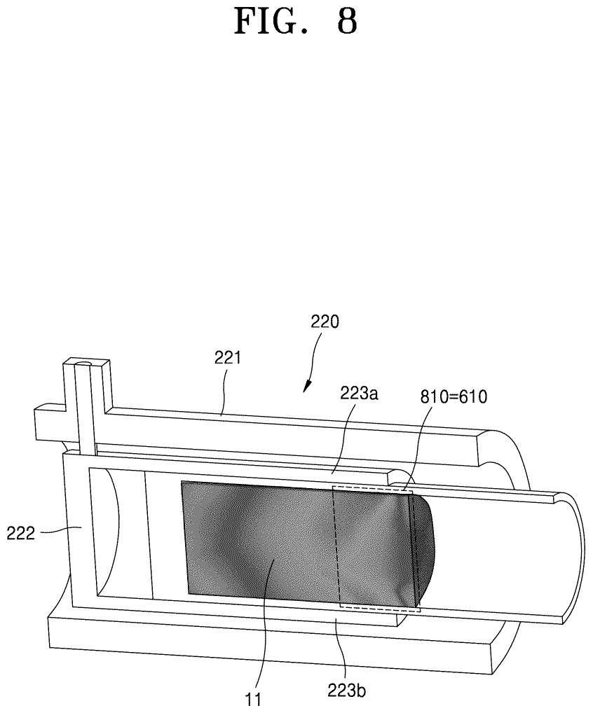

The greatest electric field generation region within a resonator is checked through an electric field distribution in FIG. 7, and the greatest electric field absorption region is checked through a heating density distribution of the tobacco rod 11 in FIG. 8.

FIG. 7 is a perspective view schematically illustrating an electric field distribution of the heater assembly according to the embodiment illustrated in FIG. 4.

The electric field distribution illustrated in FIG. 7 represents the intensity of a voltage V/m per unit length of a resonance unit.

Referring to FIG. 7, a triple resonance mode may be formed in the resonance unit 220 according to a structure of the resonance unit 220 of the heater assembly. The resonance of a TEM mode (transverse electric & magnetic mode) of microwaves is formed between the first plate 223a and the second plate 223b. Also, resonances of a TEM mode different from the resonance formed between the first plate 223a and the second plate 223b are respectively formed between the first plate 223a and an upper plate of the case 221, and between the second plate 223b and the lower plate of the case 221. In particular, it can be seen that resonance peaks are respectively formed at end portions of the first plate 223a and the second plate 223b, and stronger electric fields are generated in the end portions compared to other regions.

FIG. 8 is a perspective view schematically illustrating a heating density distribution of an aerosol generating article heated by a heater assembly according to the embodiment illustrated in FIG. 4.

The heating density distribution illustrated in FIG. 8 represents temperature energy per unit volume W/m³ in each region of an aerosol generating article being heated.

Referring to FIG. 8, a greatest heating density region 810 may be arranged in the tobacco rod 11 arranged in a direction of the end portions of the first plate 223a and the second plate 223b due to the strong electric field generated at the end portions of the first plate 223a and the second plate 223b. Heating density is related to an electric field absorption as temperature energy per unit volume, and accordingly, the greatest heating density region 810 may be the same as the greatest electric field absorption region 610.

In addition, the greatest heating density region 810 has high temperature energy per unit volume, and accordingly, a heating speed of an dielectric material in the greatest heating density region 810 is faster than in other regions. In other words, a region where the tobacco rod 11 comes into contact with the filter rod 12 is heated first. Accordingly, there is an advantage of reducing an initial suction resistance of the aerosol generating article 10.

In addition, when the greatest electric field absorption region is fixed within the tobacco rod 11, only the material placed in a certain region is quickly exhausted, and accordingly, it is not possible to provide a uniform taste of smoke throughout the entire smoking section. In order to solve this problem, the present disclosure moves the greatest electric field absorption region within the tobacco rod 11 by controlling the power supplied to the oscillating unit 210 over time.

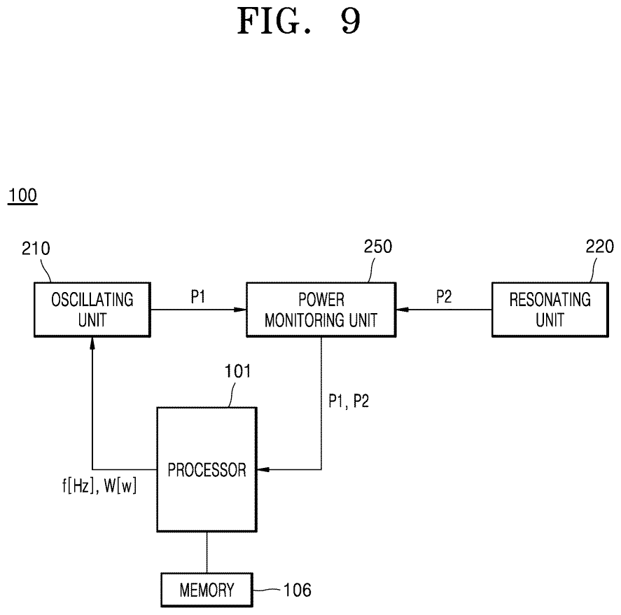

FIG. 9 is an internal block diagram illustrating a method for controlling an output of the oscillating unit according to an embodiment.

More specifically, FIG. 9 illustrates only the configurations for controlling a magnitude and frequency of the microwave power output from the oscillating unit 210 among the configurations of FIGS. 2 and 3 included in the aerosol generating device 100. Therefore, redundant descriptions given above with reference to FIG. 2 and FIG. 3 are omitted below.

Referring to FIG. 9, the aerosol generating device 100 may include a memory 106, an oscillating unit 210, a power monitoring unit 250, a resonance unit 220, and a processor 101.

The oscillating unit 210 may output a microwave with a preset output frequency and a preset power. The oscillating unit 210 may provide the generated microwave to the resonance unit 220.

The resonance unit 220 may accommodate the aerosol generating article 10 and may resonate the microwave received from the oscillating unit 210 to heat the aerosol generating article 10. An internal structure of the resonance unit 220 may be the same as illustrated in FIGS. 1 to 6.

The memory 106 may include temperature profile information and power profile information. The temperature profile includes information on a target temperature of the resonance unit 220 over time, and the processor 101 may control a magnitude of the microwave power output from the oscillating unit 210 based on the temperature profile information. Also, the power profile includes information on a target power of the oscillating unit 210 over time, and the processor 101 may control a magnitude of the microwave power output from the oscillating unit 210 based on the power profile. Hereinafter, a method for controlling the magnitude of the microwave power based on the power profile is described, and the following description may be also applied to a method for controlling the magnitude of the microwave power based on the temperature profile.

The processor 101 may control the oscillating unit 210 according to the power profile to output a first magnitude of microwave power in a preheating section. Also, the processor 101 may control the oscillating unit 210 to output microwave power of a second magnitude less than the first magnitude in a smoking section after the preheating section. Also, the processor 101 may progressively increase the magnitude of the microwave power in the smoking section. As the magnitude of the microwave power in the smoking section is progressively increased, the greatest electric field absorption region may move within the tobacco rod 11.

The oscillating unit 210 includes a power amplifier, and the processor 101 may control the power amplifier to adjust the magnitude of the microwave power described above. The power amplifier may adjust the magnitude the microwave power by increasing or decreasing an amplitude of the microwave under the control of the processor 101. For example, the processor 101 may control the oscillating unit 210 to output a microwave with any one power magnitude selected from a range of 3 W to 20 W.

In addition, the processor 101 may track a change in resonance frequency of the resonance unit 220 in real time regardless of the control of the magnitude of the microwave power described above, and enables an output frequency of the oscillating unit 210 to match a resonance frequency of the resonance unit 220. In other words, the processor 101 may match the output frequency of the oscillating unit 210 with the resonance frequency of the resonance unit 220 in real time in a state where the magnitude of the microwave power output from the oscillating unit 210 is adjusted according to the preset power profile. As the output frequency of the oscillating unit 210 is matched with the resonance frequency of the resonance unit 220, a power transfer efficiency is significantly increased, and the aerosol generating article 10 may be uniformly heated.

The power monitoring unit 250 may track the change in resonance frequency of the resonance unit 220 in real time.

More specifically, as a dielectric material included in the aerosol generating article 10 is heated and consumed by a microwave, impedance of the resonance unit 220 may change. When the oscillating unit 210 is controlled to a fixed output even though the impedance of the resonance unit 220 changes, a first impedance viewed from the oscillating unit 210 toward the resonance unit 220 may not match a second impedance viewed from the resonance unit 220 toward the oscillating unit 210. In other words, the first impedance may not match the second impedance. Also, impedance matching is related to the greatest power transfer condition, and accordingly, the greatest power transfer condition may not be satisfied. Accordingly, the power supplied from the oscillating unit 210 may not be completely transmitted to the resonance unit 220, and some of the power may be reflected from the resonance unit 220 to be input again to the oscillating unit 210.

In order to match the first impedance and the second impedance, the power monitoring unit 250 may measure a second power P2 output from the oscillating unit 210 and input to the resonance unit 220, and the second power P2 reflected from the resonance unit 220 and input to the oscillating unit 210. In this case, a first power P1 and the second power P2 may mean magnitudes of powers.

The power monitoring unit 250 may provide information on the first power P1 and the second power P2 to the processor 101.

The processor 101 may match the first impedance and the second impedance based on the information on the first power P1 and the second power P2 received from the power monitoring unit 250. Impedance matching may be achieved by adjusting an output frequency of the oscillating unit 210. This is because the impedance is a parameter related to a frequency.

The oscillating unit 210 includes at least one switching element, and the processor 101 may control on and off of the switching element in order to adjust the output frequency of the oscillating unit 210 described above.

The processor 101 may adjust the output frequency of the oscillating unit 210 such that a difference between the first power P1 and the second power P2 measured by the power monitoring unit 250 is included in a preset reference power range. For example, the reference power range may be between 0 W and 1 W but is not limited thereto.

The processor 101 may control the oscillating unit 210 such that the difference between the first power P1 and the second power P2 is included in a preset range while sweeping the output frequency output from the oscillating unit 210 within a preset reference band range. For example, the preset reference band range may be a range of 2.4 GHz to 2.5 GHz or a range of 5.7 GHz to 5.9 GHz but is not limited thereto.

In addition, adjustment of the output frequency of the processor 101 described above may be performed in real time. In other words, the processor 101 may adjust the output frequency of the oscillating unit 210 independently of the adjustment of power of the oscillating unit 210.

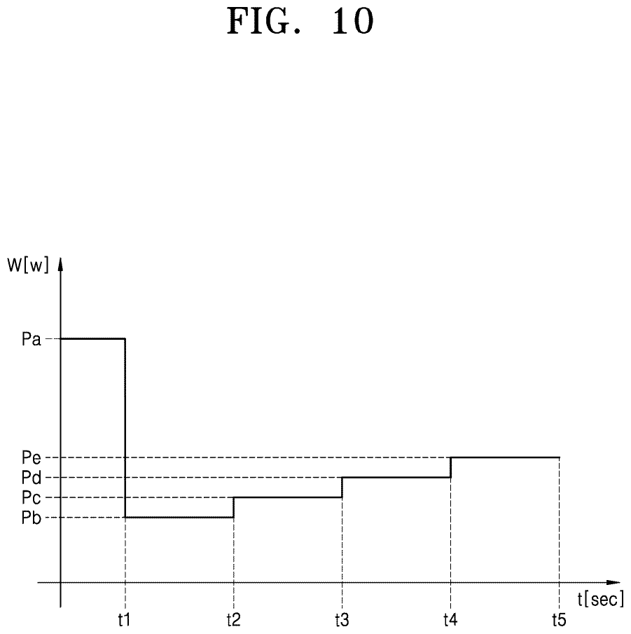

FIG. 10 is a diagram illustrating a power profile for controlling an output of the oscillating unit 210 according to the embodiment illustrated in FIG. 9.

Referring to FIG. 10, FIG. 10 illustrates a power profile according to an embodiment. The power profile includes information on a target power in a preheating section and a smoking section. In FIG. 10, the preheating section may be equal to the first time t1, and the smoking section may mean a period from the first time t1 to fifth time t5. For example, the first time t1 may be 20 seconds, and the fifth time t5 may be 4 minutes and 30 seconds or more but are not limited thereto.

The processor 101 may control the oscillating unit 210 during the first time t1 to cause microwave power of a first magnitude Pa to be output. For example, the first magnitude Pa may be 20 W.

In addition, the first time t1 is equal to the preheating section, and a target power of the first time t1 is independent of a movement of a greatest electric field absorption region. In other words, the fact that the first magnitude Pa is greater than a second magnitude Pb to a fifth magnitude Pe described below is to rapidly heat the tobacco rod 11 and is maintained only for a short time, such as 20 seconds, and accordingly, not only a dielectric material is not completely depleted in a certain region of the tobacco rod 11, but also a relatively high power is supplied to the resonance unit 220, and the dielectric material is quickly heated as a whole. Therefore, there is no need to move the greatest electric field absorption region in the preheating section.

The processor 101 may control the oscillating unit 210 from the first time t1 to second time t2 to output microwave power of the second magnitude Pb less than the first magnitude Pa. A difference between the second time t2 and the first time t1 may be greater than the first time t1. For example, the difference between the second time t2 and the first time t1 may be 1 minute and 30 seconds but is not limited thereto. Also, the second magnitude Pb may be any one selected from a range of 3 w to 4 w.

When the microwave power of the second magnitude Pb is output to the resonance unit 220, a greater electric field may be output to a part of the tobacco rod 11, and thus, a greatest electric field absorption region may be generated in the tobacco rod 11.

When the greatest electric field absorption region of the tobacco rod 11 is not moved, the electric field is concentrated in a certain region, and accordingly, the tobacco rod 11 is not uniformly heated. Therefore, the processor 101 progressively increases the microwave power to move the greatest electric field absorption region of the tobacco rod 11 in the smoking section.

The processor 101 may control the oscillating unit 210 from the second time t2 to third time t3 such that the microwave power of a third magnitude Pc greater than the second magnitude Pb is output. A difference between the third time t3 and the second time t2 may be equal to or greater than the difference between the second time t2 and the first time t1. For example, the difference between the third time t3 and the second time t2 may be 1 minute and 30 seconds or more and may be less than 2 minutes but is not limited thereto. Also, the third magnitude Pc may be any one selected from a range of 4 w to 5 w. As the oscillating unit 210 outputs the microwave power of the third magnitude Pc that is greater than the second magnitude Pb, the greatest electric field absorption region may be moved within the tobacco rod 11.

The processor 101 may control the oscillating unit 210 from the third time t3 to fourth time t4 such that microwave power of a fourth magnitude Pd that is greater than the third magnitude Pc is output. A difference between the fourth time t4 and the third time t3 may be equal to or greater than the difference between the third time t3 and the second time t2. For example, the difference between the fourth time t4 and the third time t3 may be 1 minute and 30 seconds or more and may be less than 2 minutes but is not limited thereto. Also, the fourth magnitude Pd may be any one selected from a range of 5 w to 6 w. As the oscillating unit 210 outputs the microwave power of the fourth magnitude Pd that is greater than the third magnitude Pc, the greatest electric field absorption region may be moved within the tobacco rod 11.

The processor 101 may control the oscillating unit 210 from the fourth time t4 to fifth time t5 such that microwave power of a fifth magnitude Pe that is greater than the fourth magnitude Pd is output. A difference between the fifth time t5 and the fourth time t4 may be equal to or greater than the difference between the fourth time t4 and the third time t3. For example, the difference between the fifth time t5 and the fourth time t4 may be 1 minute and 30 seconds or more and may be less than 2 minutes but is not limited thereto. Also, the fifth magnitude Pe may be any one selected from a range of 6 w to 7 w. As the oscillating unit 210 outputs the microwave power of the fifth magnitude Pe that is greater than the fourth magnitude Pd, the greatest electric field absorption region may move within the tobacco rod 11.

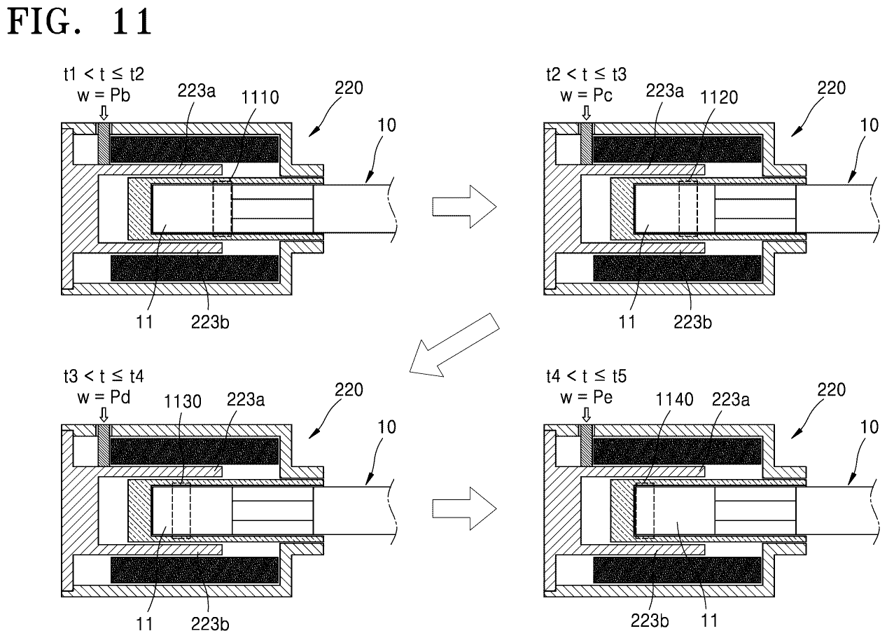

FIG. 11 is a view illustrating a movement of the greatest electric field absorption region according to the power profile according to the embodiment illustrated in FIG. 10.

Referring to FIG. 11, the processor 101 may control the oscillating unit 210 in a first section of a smoking section such that the microwave power of the second magnitude Pb is output. The first section may indicate a section from the first time t1 to the second time t2, and the second magnitude Pb may be any one selected from a range of 3W to 4W. When the microwave power of the second magnitude Pb is output, a resonance peak is formed at the end portions of the first plate 223a and the second plate 223b of the resonance unit 220, and a stronger electric field is generated at the end portions compared to other regions. Accordingly, the greatest electric field absorption region may be generated in a first region 1110 of the tobacco rod 11 arranged in an end portion direction of the first plate 223a and the second plate 223b.

In addition, the aerosol generating device 100 of the present disclosure has an advantage of reducing an initial suction resistance of the aerosol generating article 10 because the first region 1110, which is a portion where the tobacco rod 11 is in contact with a filter rod, is heated first. However, when the greatest electric field absorption region is fixed in the entire section of the heating section, there is a problem in that the tobacco rod 11 is not heated uniformly. Therefore, the processor 101 progressively increases the microwave power to move the greatest electric field absorption region of the tobacco rod 11 in the smoking section.

The processor 101 progressively increases a magnitude of the microwave power output from the oscillating unit 210 such that the greatest electric field absorption region moves in a longitudinal direction of the tobacco rod 11. As the magnitude of the microwave power output from the oscillating unit 210 increases, the greatest electric field absorption region in the tobacco rod 11 moves in an opposite direction toward an opening in which the aerosol generating article 10 is accommodated, as illustrated in FIG. 11.

More specifically, the processor 101 may control the oscillating unit 210 in a second section after the first section of the smoking section to output microwave power of the third magnitude Pc that is greater than the second magnitude Pb. The second section may indicate a section from the second time t2 to the third time t3. There is no dielectric material in the filter rod, and because the dielectric material in the first region 1110 is considerably consumed in the first section, when the microwave power increases to the third magnitude Pc, the greatest electric field absorption region moves to a second region 1120 in the opposite direction toward the opening in which the aerosol generating article 10 is accommodated.

The processor 101 may control the oscillating unit 210 in a third section after the second section to move the greatest electric field absorption region of the tobacco rod 11 once again, and accordingly, microwave power of the fourth magnitude Pd that is greater than the third magnitude Pc may be output. A third section may indicate a section from the third time t3 to the fourth time t4. Likewise, there is no dielectric material in the filter rod, and because the dielectric material in the second region 1120 is considerably consumed in the second section, when the microwave power increases to the fourth magnitude Pd, the greatest electric field absorption region moves to a third region 1130 in an opposite direction toward the opening in which the aerosol generating article 10 is accommodated.

The processor 101 may control the oscillating unit 210 in a fourth section after the third section to move the greatest electric field absorption region of the tobacco rod 11 once again, and accordingly microwave power of the fifth magnitude Pe that is greater than the fourth magnitude Pd may be output. A fourth section may indicate a section from the fourth time t4 to the fifth time t5. Likewise, there is no dielectric material in the filter rod, and because the dielectric material the third region 1130 is considerably consumed in the third section, when the microwave power increases to the fifth magnitude Pd, the greatest electric field absorption region moves to a fourth region 1140 in the opposite direction toward the opening in which the aerosol generating article 10 is accommodated. In addition, FIG. 11 only illustrates a method of progressively increasing microwave power according to a total of four sections, and the four sections may increase or decrease depending on lengths of media and magnitudes of the microwave power.

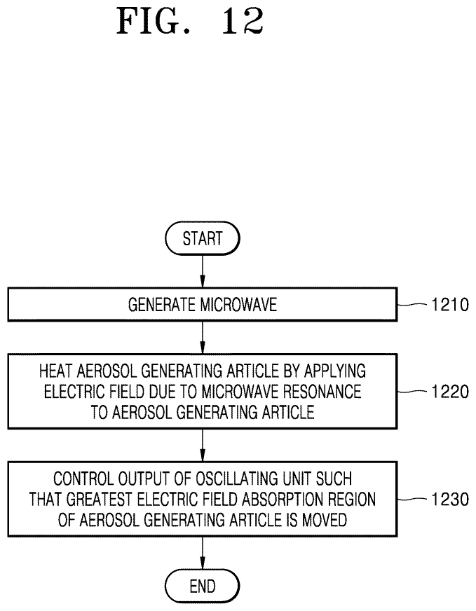

FIG. 12 is a flowchart illustrating an operating method of an aerosol generating device, according to an embodiment.

Referring to FIG. 12, in step 1210, the oscillating unit 210 may generate a microwave.

The oscillating unit 210 may include a solid-state-based radio frequency (RF) generating device and generate microwaves by using the RF generating device.

The oscillating unit 210 may output a microwave with a preset output frequency and a preset magnitude of power under the control of the processor 101.

The oscillating unit 210 may include a power amplifier, and the power amplifier may adjust the magnitude of microwave power under the control of the processor 101. For example, the power amplifier may decrease or increase an amplitude of the microwave. By adjusting the amplitude of the microwave, the microwave power may be adjusted.

In step 1220, the resonance unit 220 may heat the aerosol generating article 10 by applying an electric field due to microwave resonance to the aerosol generating article 10.

As illustrated in FIG. 4 to FIG. 8, the resonance unit 220 may include the first plate 223a surrounding one region of the aerosol generating article 10, the second plate 223b separated from the first plate 223a in a circumferential direction of the aerosol generating article 10 and surrounding another region of the aerosol generating article 10, and the connector 222 connecting the first plate 223a to the second plate 223b. By the first plate 223a, the second plate 223b, and the connector 222, microwaves may respectively resonate (so-called a triple resonance structure) between the first plate 223a and the second plate 223b, and between each of the first and second plates 223a and 223b and the case 221, and the aerosol generating article 10 may be heated by an electric field due to the microwave resonance.

In particular, lengths of the first plate 223a and the second plate 223b may be less than a length of the tobacco rod 11 included in the aerosol generating article 10, and accordingly, the tobacco rod 11 may be arranged at a position protruding from end portions of the first plate 223a and the second plate 223b in a direction toward an opening in which the aerosol generating article 10 is accommodated. Because a stronger electric field is generated at the end portions of the first plate 223a and the second plate 223b, a greatest electric field absorption region may be generated in a preset region of the tobacco rod 11 arranged in a direction of the end portions of the first plate 223a and the second plate 223b at the beginning of heating. The beginning of heating may mean a period of time after the start of a smoking section until a preset time elapses.

In addition, when the greatest electric field absorption region is fixed within the tobacco rod 11, only the dielectric material placed in a preset region is quickly exhausted, and accordingly, a uniform taste of smoke may not be provided throughout the entire smoking section. In order to solve the problem, the present disclosure moves the greatest electric field absorption region within the tobacco rod 11 by increasing a magnitude of microwave power in the smoking section.

In step 1230, the processor 101 may control an output of the oscillating unit 210 such that the greatest electric field absorption region of the aerosol generating article 10 is moved.

The processor 101 may adjust a magnitude of the microwave power output from the oscillating unit 210 according to a preset power profile such that the greatest electric field absorption region of the aerosol generating article 10 is moved.

The processor 101 may control the oscillating unit 210 such that the microwave power of the first magnitude Pa is output in a preheating section. In addition, in the preheating section, the microwave power is relatively large, such as 20 W, and the preheating section is maintained for a relatively short time, such as 20 seconds, and accordingly, there is little need to move the greatest electric field absorption region. In other words, because relatively high power is supplied to the resonance unit 220 for a relatively short time in the preheating section, a dielectric material is quickly heated as a whole, and thus, there is little need to move the greatest electric field absorption region in the preheating section.

When the smoking section starts after the preheating section, the processor 101 may control the oscillating unit 210 to output microwave power of the second magnitude Pb that is less than the first magnitude Pa. As the smoking section progresses, the processor 101 may progressively increase the power output from the oscillating unit 210 such that the greatest electric field absorption region is moved.

In one embodiment, the processor 101 may control the oscillating unit 210 in the first section of the smoking section to output the microwave power of the second magnitude Pb. Also, the processor 101 may control the oscillating unit 210 in the second section after the first section to output microwave power of the third magnitude Pc that is greater than the second magnitude Pb. Also, the processor 101 may control the oscillating unit 210 to output microwave power of a fourth magnitude Pd that is greater than the third magnitude Pc in the third section after the second section, and to output microwave power of a fifth magnitude Pe that is greater than the fourth magnitude Pd in the fourth section after the third section.

As the microwave power progressively increases in the smoking section, the greatest electric field absorption region moves in a longitudinal direction of the tobacco rod 11. In one embodiment, the greatest electric field absorption region may move within the tobacco rod 11 in an opposite direction to a direction toward the opening in which the aerosol generating article 10 is accommodated.

In addition, the processor 101 may track in real time a change in resonance frequency of the resonance unit 220 due to the exhaustion of a dielectric material included in the aerosol generating article 10, regardless of the power profile. Also, the processor 101 may adjust an output frequency of the microwave power output from the oscillating unit 210 based on the change in resonance frequency. In other words, the processor 101 may independently control a magnitude of the microwave power output from the oscillating unit 210 and an output frequency of the microwave power.

Any of the embodiments or other embodiments of the disclosure described above are not mutually exclusive or distinct. Any of the embodiments or other embodiments of the disclosure described above may be combined or used together in respective configurations or functions thereof.

For example, a configuration A described in a certain embodiment and/or a drawing may be combined with a configuration B described in another embodiment and/or drawing. That is, even when coupling of configurations is not directly described, the coupling may be made except a case in which the coupling is described to be impossible.

The above detailed description should not be construed as limiting in all aspects and should be considered as illustrative. The scope of the disclosure should be determined by a reasonable interpretation of the appended claims, and all changes within the equivalent scope of the disclosure are included in the scope of the disclosure.

1. An aerosol generating device comprising:
an oscillating unit configured to generate a microwave;
a resonance unit configured to accommodate an aerosol generating article and heat the aerosol generating article by applying an electric field due to microwave resonance to the aerosol generating article; and
a processor configured to control an output of the oscillating unit such that a greatest electric field absorption region of the aerosol generating article is moved.

2. The aerosol generating device of claim 1, wherein
the resonance unit includes a first plate surrounding one region of the aerosol generating article, a second plate separated from the first plate in a circumferential direction of the aerosol generating article and surrounding another region of the aerosol generating article, and a connector configured to connect the first plate to the second plate, and
the microwave is resonated by the first plate, the second plate, and the connector, and the aerosol generating article is heated by the electric field output from end portions of the first plate and the second plate.

3. The aerosol generating device of claim 2, wherein lengths of the first plate and the second plate are less than a length of a tobacco rod included in the aerosol generating article, the tobacco rod is arranged at a position protruding from the end portions of the first plate and the second plate in a direction toward an opening in which the aerosol generating article is accommodated, and the greatest electric field absorption region is generated in a preset region of the tobacco rod arranged in a direction of the end portions of the first plate and the second plate at beginning of heating.

4. The aerosol generating device of claim 1, wherein the processor is further configured to control the output of the oscillating unit such that the greatest electric field absorption region is moved in a longitudinal direction of the tobacco rod included in the aerosol generating article.

5. The aerosol generating device of claim 4, wherein the greatest electric field absorption region is moved within the tobacco rod in an opposite direction to a direction toward an opening in which the aerosol generating article is accommodated.

6. The aerosol generating device of claim 1, wherein the processor is further configured to adjust a magnitude of microwave power output from the oscillating unit according to a preset power profile such that the greatest electric field absorption region of the aerosol generating article is moved.

7. The aerosol generating device of claim 6, wherein the processor is further configured to control the oscillating unit to output microwave power of a first magnitude in a preheating section.

8. The aerosol generating device of claim 7, wherein, when a smoking section starts after the preheating section, the processor is further configured to control the oscillation unit to output microwave power of a second magnitude that is less than the first magnitude, and as the smoking section progresses, the processor is configured to progressively increase the microwave power output from the oscillating unit such that the greatest electric field absorption region is moved.

9. The aerosol generating device of claim 1, wherein the processor is further configured to track in real time a change in a resonance frequency of the resonance unit due to exhaustion of a dielectric material included in the aerosol generating article, and adjust an output frequency of microwave power output from the oscillating unit based on the change in the resonance frequency of the resonance unit.

10. The aerosol generating device of claim 9, wherein the processor is further configured to independently control a magnitude of the microwave power and the output frequency of the microwave power.
